(19) United States
(12) Patent Application Publication
(10) Pub. No.: US 2004/0009766 A1
(43) Pub. Date: Jan. 15, 2004

(54) Method for providing traffic information to radiotelephones

(76) Inventor: Seung-Woo Hong, Seoul (KR)

Correspondence Address: FULBRIGHT & JAWORSKI, LLP, 666 FIFTH AVE, NEW YORK, NY, 10103-3198, US

(21) Appl. No.: 10/363,373

(22) PCT Filed: Aug. 10, 2001
(86) PCT No.: PCT/KR01/01368

(30) Foreign Application Priority Data
Aug. 28, 2000 (KR) 2000/50031

(51) Int. Cl. H04Q 7/20

(52) U.S. Cl. 455/422.1; 455/453

(57) ABSTRACT

The present invention discloses a method for providing real-time traffic information using a mobile communication terminal through wireless internet, comprising the steps of receiving a request for image by a WAP server when a user requests traffic information image via a mobile communication terminal; analyzing the specification of the mobile communication terminal by the server that has recieved the request; analyzing the type of the image requested by the user and traffic of the requested section by the server; receiving an image that the user has requested by the server; producing an image optimized for the user's mobile communication terminal based on the image received by the server; and tramsitting the optimized image to the wireless mobile communication terminal(of the user) using a WAP protocol by the server.

### TECHNICAL FIELD OF THE INVENTION

The present invention relates generally to a method for providing real-time traffic information using a mobile phone through wireless internet, and specifically to a method for providing traffic information image which allows a user to directly view real-time traffic image (including motion image) using a mobile communication terminal, and thus, to personally confirm the status of the traffic of desired section.

### BACKGROUND OF THE INVENTION

Due to the drastic increase of the number of automobiles on the street more and more sections of the street become bottle necked and the increasing number of traffic accidents worsens the traffic situation additionally. From this background it is increasingly important for a driver to quickly obtain traffic information on the roads en route, and to find a detour avoiding the traffic jam areas. For obtaining traffic information, the drivers have conventionally relied heavily on the traffic broadcasting.

Conventionally, traffic information has principally been provided by the traffic broadcasting station which releases at predetermined intervals traffic information gathered by its correspondents staying at the traffic control center of the municipal police office, or at important traffic points. This method is inconvenient in that the audience should continue listening the broadcasting and wait for the traffic information relevant to his route. Once traffic information pertinent to the route is provided, the driver shall still carefully listen to the broadcasting, since he does not know when the next relevant information will be released, thus, not allowing him to fully concentrate on driving and increasing the probability of a traffic accident. In addition, this method is inconvenient in that it does not allow the driver to listen to another broadcasting program or to play a cassette tape during listening to the traffic broadcasting.

In order to solve the above described problems of the traffic broadcasting, text-type traffic information service using wireless pager and text-type traffic information service using mobile communication terminal through wireless internet have been provided.

Although these methods, in contrast to the above traffic broadcasting, allow a user to obtain traffic information of a desired area at times the user chooses, they are restricted to providing traffic information relying only on text information.

In other words, the shortage of these methods is not to comply with the need of a user to directly confirm the actual traffic situation of a desired area by real-time image of the traffic site.

### DETAILED DESCRIPTION OF THE INVENTION

The present invention, conceived in view of the above demand, aims to provide a method for providing traffic information using a mobile phone through wireless internet, capable of providing real-time image of the traffic status of an area selected by the user.

The present invention further aims to provide a method for providing a custom made traffic information on the roads neighboring to the current location of the user, by automatically recognizing the present location of the user.

The present invention further aims to provide a method for providing traffic information, wherein an administrator of the traffic information providing system is also allowed to remotely control and monitor the traffic facilities such as the cameras via the wireless mobile communication terminal.

### BRIEF DESCRIPTION OF THE DRAWINGS

FIG. 1 shows a schematic construction of the system used in the method of providing traffic information in accordance with the present invention.

FIG. 2 shows a schematic construction of another embodiment of the system used in the method of providing traffic information in accordance with the present invention.

FIG. 3 shows a schematic construction of software used in the system for the method of providing traffic information in accordance with the present invention.

FIGS. 4a through 4f show examples of the interfaces provided to the wireless mobile communication terminals of the user in the method of providing traffic information in accordance with the present invention.

FIG. 5 is a chart illustrating the actual sequence of steps in providing an image requested by a user in the method of providing traffic information in accordance with the present invention.

FIG. 6 is a chart illustrating the steps of image conversion used in the method of providing traffic information in accordance with the present invention.

### DESCRIPTION OF THE PREFERRED EMBODIMENTS

Now, a description of the preferred embodiment of the present invention is given below, making reference to the accompanying drawings.

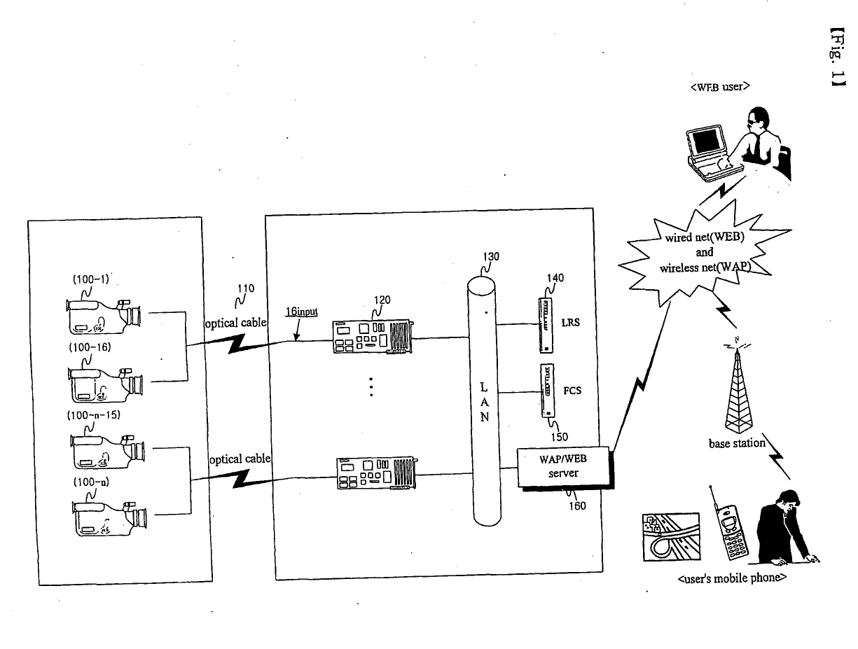

FIG. 1 shows a schematic construction of the system used in the method of providing traffic information in accordance with the present invention.

Referring to FIG. 1, the system of the present invention comprises system cameras 100-1, . . . , 100-n, optical cable 110, video server 120, LAN cable 130, motion image relay server 140, file conversion server 150, and WAP/WEB server 160.

The functions of each component are briefly explained below:

The cameras 100-1, . . . , 100-n, installed at locations from where images of the important traffic areas can be taken, serve to deliver images of the exact traffic status of desired area to the user.

The image information from the cameras 100-1, . . . , 100-n is then transmitted through the optical cable 10 to the video server 120.

The video server 120, motion image server 140, file conversion server 150, and WAP/WEB server 160 are interconnected via the LAN cable 130.

The video server 120 compresses image information from the cameras 100-1, . . . , 100-n utilizing a motion image compression means such as MPEG (Motion Pictures Experts Group) or the like. The video server 120 is capable of processing images from a multiple of cameras to compress the images into MPEG format, a good example of which is shown in the FIG. 1, where one video server 120 is designed to process image information from 16 cameras.

The motion image relay server (LRS) 140, upon request of a user for motion image traffic information after the user has connected to the WAP/WEB server 160, fetches the image information in MPEG format from the above video server 120, processes the image information into a format suitable to be transmitted as motion image via wireless internet, and then provides the processed image information to the WAP/WEB server 160.

The file conversion server (FCS) 150, upon request of a user for still image traffic information after the user has connected to the WAP/WEB server 160, fetches the motion image information in MPEG format as compressed by the above video server 120, and further converts the image information into a format suitable to be transmitted as still image, e.g., into JPEG (Joint Photographic Experts Group), which is an international standard for compression and coding of still images.

The WAP/WEB server 160 serves to provide a connection through WEB to a user wishing a wired internet connection via a computer, while it serves to provide with a connection through WAP to a user wishing a connection to the internet via wireless mobile communication terminal. Since the present invention primarily relates to a method for providing traffic information using wireless internet, the WAP/WEB server 160 is indicated as abridged to WAP server 160 herein below.

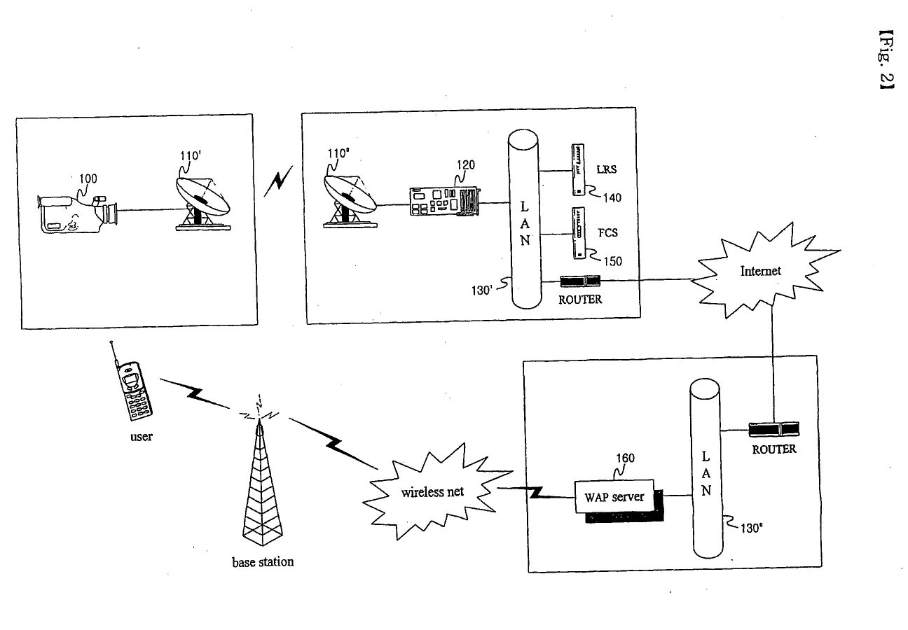

FIG. 2 shows a schematic construction of another embodiment of the system used in the method of providing traffic information in accordance with the present invention.

Though looking similar to FIG. 1 in the main parts, FIG. 2 has a construction, wherein the camera 100 and the video server 120 are connected by wireless antennas 110′, 110″, instead of the optical cable 110 in FIG. 1, allowing the camera 100 and the video server 120 to easily exchange image information with each other even from distant location.

Referring to FIG. 2, the video server 120, the motion image relay server 140 and the file conversion server 150 are connected via the LAN cable, while the WAP server 160 is located distantly from the above three servers, so that it can be run by a separate operator at different location.

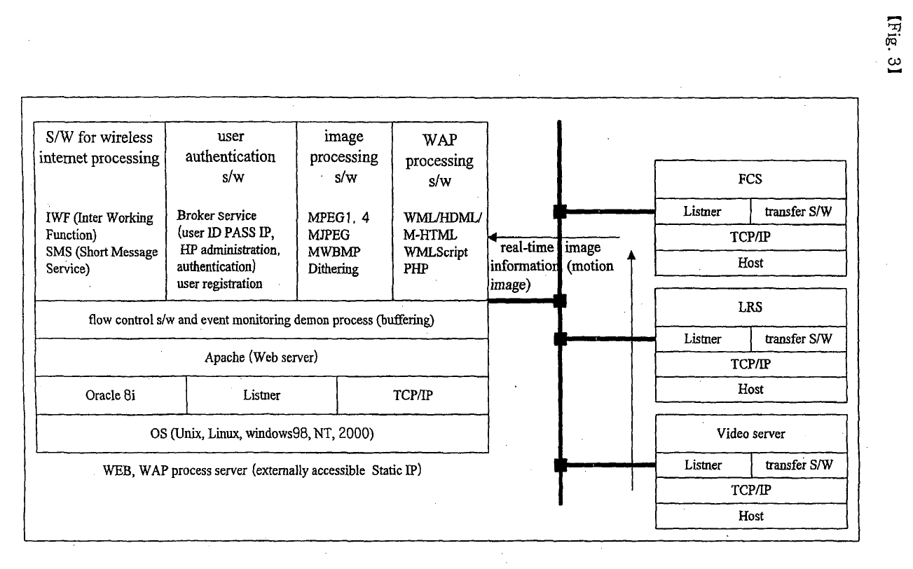

FIG. 3 shows a schematic construction of software used in the system for the method of providing traffic information in accordance with the present invention.

Referring to FIG. 3, each of the video server 120, the motion image relay server 140, and the file conversion server 150 comprises TCP/IP transfer protocol as well as transfer software.

The WAP server 160 comprises a wireless net processing software, a user authentication software, an image processing software, and a WAP processing software.

When a user accesses the WAP server 160 using a wireless mobile communication terminal, a user authentication is performed utilizing the user authentication software; then, upon request of the user for desired image information, image information from the camera(s) is processed to a suitable image format utilizing the image processing software; the information to be transferred, such as the above image information, text information, etc. is then WAP processed to a format suitable for wireless internet transfer utilizing the WAP processing software; and the image information and text information thus processed are then transferred to the wireless internet using the wireless net processing software.

The functions of each software are explained in detail below:

The user authentication software serves to provide a broker service by administering and authenticating users' IDs, passwords, IP, HP, etc. as well as a user registration service.

The image processing software, being a software for processing the image information from the cameras 100-1, . . . , 100-n to an image format which the user desires, comprises MPEG 1,4 for providing motion images, MJPEG and MWBMP for providing still images, and a software capable of dithering function, allowing a gray image to be displayed on a black and white display device.

The WAP processing software that processes the data into a format fit to a wireless communication terminal, comprises WML/HDML/M-HDML/WML/Script/PHP, etc.

The wireless net processing software performs IWF (Inter Working Function) for transfer and conversion of data via wireless net, and provides SMS (Short Message Service) for transfer of short messages.

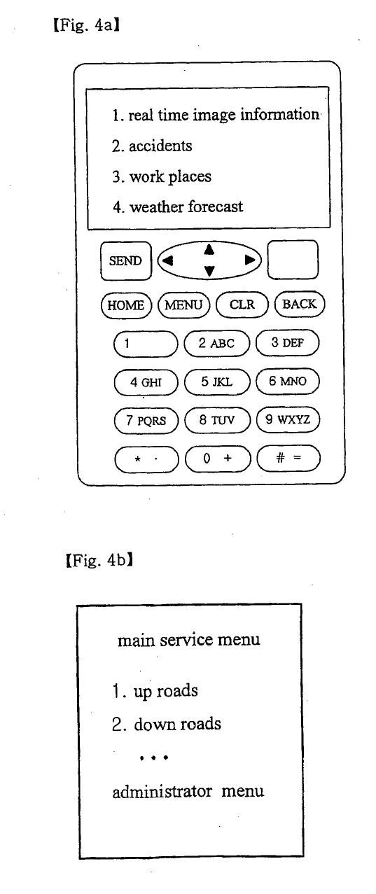

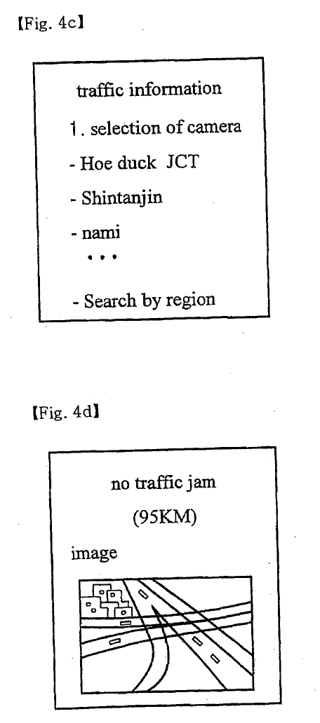

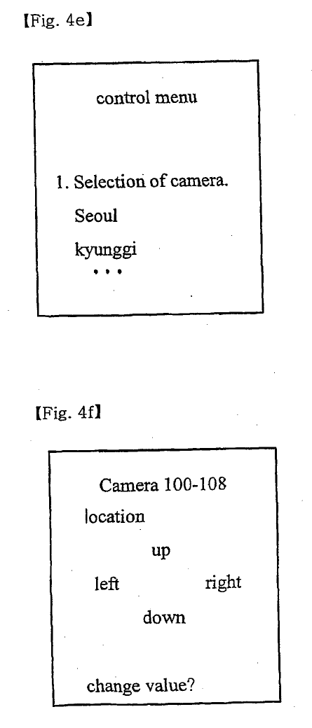

Next, the method of providing traffic information using a mobile communication terminal as per the present invention is explained below based on the user interfaces to be shown on the mobile communication terminal, examples of the interfaces being illustrated in FIGS. 4a through 4f.

First, after a user accesses the internet using a mobile communication terminal and takes steps for user authentication, the WAP server 160 provides a traffic information screen as illustrated in FIG. 4a, allowing the user to select from the various traffic information service menu.

If the user clicks e.g. the real time image information menu in FIG. 4a, the WAP server 160 provides the main service menu screen as illustrated in FIG. 4b. In this case, the WAP server 160 automatically recognizes the current location of the user and provides geographical information menu based on that location of the user. For example, if a user selects the up roads menu in FIG. 4b while located near Taejeon city, a list of cities in the up road section from Taejeon city, comprising Hoedeok, Sintanjin, Nami, etc. is provided in FIG. 4c. If the user further selects a specific area in FIG. 4c, image information on the current traffic status of that area and text information such as “no traffic jam” are provided as illustrated in FIG. 4d. The above image information comprises still image as well as motion image: Although a still image can provide an image of superior quality based on the current transfer speed on the wireless internet, providing of motion image is also feasible in view of the rapid technological developments relating to the transfer speed.

The system in accordance with the present invention further provides an additional service for the administrator, i.e. an administrator menu. In other words, if the administrator finds the location of the camera(s) by viewing FIG. 4d to be incorrect, or he decides otherwise to control the location of the camera(s), he can select the administrator menu in FIG. 4b. In such a case, input of the administrator ID, passwords, etc. can be requested for confirmation of the administrator. Then, the administrator can select the camera 100-108 to be controlled in FIG. 4e, and further change/control the location of the camera 100-108 in four directions, i.e., up, down, left, and right in FIG. 4f.

Next, the method of providing traffic information in optimized image in accordance with the present invention upon request of a user as described above is explained in detail below.

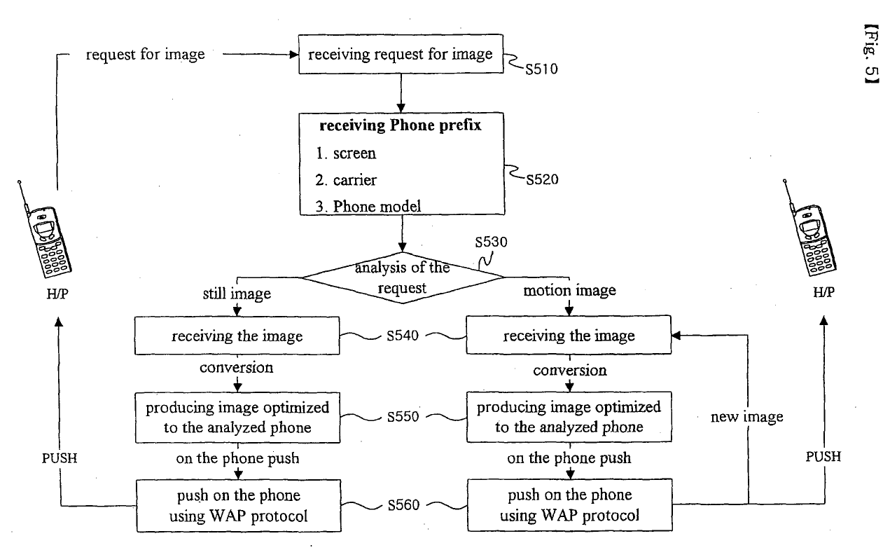

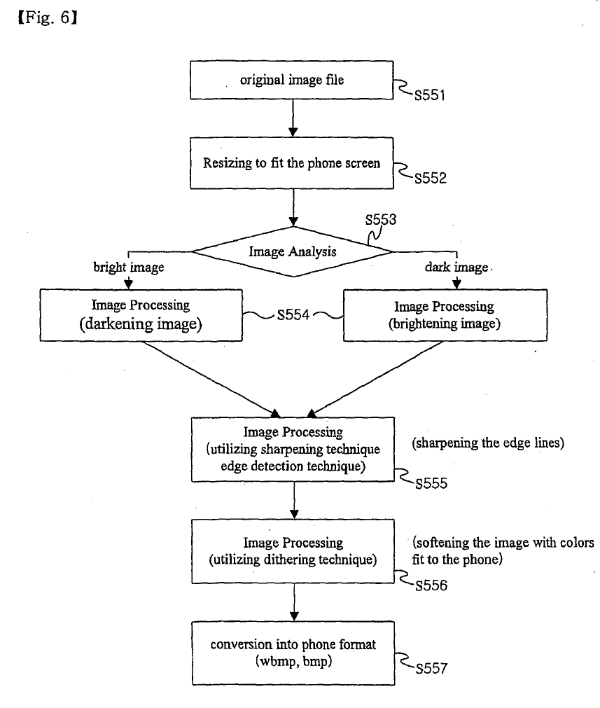

FIG. 5 illustrates the actual steps of providing the image requested by the user in accordance with the present invention.

If a user requests for certain image in order to obtain desired traffic information using a mobile communication terminal, the WAP server 160 receives the request for image (S510).

As described above, location of the user is automatically recognized at step S510. Here, a step wherein the server 160 automatically recognizes the current location of the user and provides the user with geographical information based on the present location of the user, and a step wherein the user selects a specific area from the above geographical information menu and receives the requested information can be added.

It is further possible in step 510 to check whether the user selects the administrator menu and to provide him with the administrator menu, in which case additional steps can be added, comprising the step of providing a screen for selection of the administrator menu, the step of providing a screen for selection of the camera to be controlled 100-1, . . . , 100-n if the user has selected the administrator menu in the above screen, and the step of providing a screen for change/control of the selected camera in four directions if the user has selected a specific camera.

As next, the server 160 which has received the above request for image analyzes the Phone prefix (specification) of the user's mobile communication terminal such as the size of LCD screen, the carrier (011, 016, 017, 018, 019), the model No. of the phone, etc. at step S520.

The server 160 proceeds then to analyze whether the user requests for still image or motion image at step S530.

The server 160 receives the images requested by the user at step S540.

The above WAP server 160 continues to receive the images, stores them separately by each camera, and prepares to transfer the most recent images among the images it receives real time to the user upon request thereof.

And then, images optimized to the analyzed mobile communication terminal is produced at step S550. In practice, this means the production of converted images capable of optimally showing the newest image on the mobile communication terminal, an explanation thereof follows in reference to the relevant drawing. FIG. 6 shows the steps of image conversion used in the method of providing traffic information as per the present invention.

The subject of conversion is the most recent original image file (S551) which file is resized to adjust to the screen of the mobile communication terminal (S552).

Next, the brightness of the resized image is analyzed (S553), and, if it is brighter than a predetermined degree, controlled to be darker, or, if it is darker than a predetermined degree, controlled to be brighter, to yield an optimized brightness (S554).

Then, edge lines of the image are made sharper utilizing sharpening technique, edge detection technique, etc. (S555), and a soft image suitable for a mobile communication terminal is produced using dithering technique as described above (S556).

The above converted image is then transformed into a file format (e.g., wbmp, bmp) appropriate for transfer to the corresponding mobile communication terminal (S557). In other words, the video server 120 transforms the image information form the camera 100-1, . . . , 100-n into frames in MPEG format having 30 frames per second.

After that, the above images in a format of 30 frames per second is transferred as it is in case of WEB transfer via wired internet, because the WEB transfer operates to transfer images by frames. However, since the WAP transfer via wireless internet as per the subject invention operates to transfer image by cards, i.e., at a current standard of 5 cards per second, the above images in MPEG format having 30 frames per second is changed by a frame conversion device to images in MPEG format having 5 frames per second. In practice, 5 frames can be selected in predetermined intervals from among the 30 frames, the selected 5 frames per second can then be transformed into card format, and further conversed to a format compatible to the mobile communication terminal.

Finally, the server 160 transfers the image as optimized in above manner to the wireless mobile communication terminal using the WAP protocol at step S560.

Referring to FIG. 5, the image transfer process terminates with sending of one image in case of still image, while new images are transmitted with flow of the time in case of motion image. In other words, in case of still image, the server 160 selects upon receipt of a user's request the most recent frame from among the selected 5 frames per second and then transmits it in card format; in case of motion image, the server 160 maintains to receive the image continuously at the above step S540, converts the image frame into one having 5 frames per second, and then transmits the converted images in card format. Here, it is preferable that the next image is sent in consideration of the transfer speed on the wireless internet, not necessary bound to 5 frames per second. The continuous sending of the image to a mobile communication terminal is performed using the timer function of WML in a manner that the timer speed coincide with the present data transfer speed of the wireless internet so that images can be transferred to the mobile communication terminal according to the data transfer speed of the network.

Although the present invention has been described above with reference to the preferred embodiment, the scope of the rights of the subject invention is not restricted thereto, but rather shall be determined by the claims attached herein below and their equivalents, allowing various alterations, modifications, and adjustments, as those skilled in the art will understand.

Industrial Applicability

As described above, the present invention allows a user to directly confirm the current traffic status of selected area by providing real time still image or motion image of the traffic using a mobile communication terminal via wireless internet.

Further, the present invention is capable of providing custom-made traffic information on the area adjacent to the present location of the user by automatically recognizing the present location of the user.

The present invention further allows the administrator of the traffic information providing system to remotely monitor and control the facilities such as cameras and the like through a mobile communication terminal.

What is claimed is:

1. A method for providing real-time traffic information using a mobile communication terminal through wireless internet, comprising:
the first step of receiving a request for image by a WAP server when a user requests traffic information image via a mobile communication terminal;
the second step of analyzing the specification of the mobile communication terminal by the server that has received the request;
the third step of analyzing the type of the image requested by the user and the traffic of the requested section by the server;
the fourth step of receiving an image that the user has requested by the server;
the fifth step of producing an image optimized for the user's mobile communication terminal based on the image received by the server; and
the sixth step of transmitting the image as optimized using a WAP protocol by the server to the wireless mobile communication terminal.

2. The method for providing real-time traffic information using a mobile communication terminal through wireless internet as set forth in claim 1, wherein the specification of said mobile communication terminal in said second step comprises the size of LCD screen of the mobile communication terminal, carrier type, and model no. of the phone.

3. The method for providing real-time traffic information using a mobile communication terminal through wireless internet as set forth in claim 1, wherein said fifth step further comprises the steps of:
5-1, wherein the size of the image file received at said fourth step is readjusted to the screen size of the mobile communication terminal;
5-2, wherein the brightness of said image as readjusted in size is analyzed and readjusted to yield an appropriate brightness;
5-3, wherein the edge lines of said image are made sharper utilizing sharpening technique and edge detection technique; and
5-4, wherein a soft image suitable for a mobile communication terminal is produced from said image using the dithering technique.

4. The method for providing real-time traffic information using a mobile communication terminal through wireless internet as set forth in claim 3, wherein each of said fourth and said sixth step comprises an additional step of 4-1 and 6-1 respectively, when the user requests for motion image:
4-1, wherein the next image is transmitted anew when a predetermined time has elapsed; and
6-1, said next images are sent continuously in consideration of the transfer speed on the wireless internet.

5. The method for providing real-time traffic information using a mobile communication terminal through wireless internet as set forth in claim 4, wherein the continuous sending of the images in said step of 6-1 is performed using the timer function of WML so as to coincide with the present transfer speed on the wireless internet.

6. The method for providing real-time traffic information using a mobile communication terminal through wireless internet as set forth in claim 1, wherein said first step further comprises the steps of:
1-1, wherein a custom made traffic information on the roads neighboring to the current location of the user is provided, by automatically recognizing the present location of the user; and
1-2, wherein the relevant traffic information is received if the user selects specific region among said traffic information.

7. The method for providing real-time traffic information using a mobile communication terminal through wireless internet as set forth in claim 1, wherein said first step further comprises the steps of:
1-3, wherein a screen for selection of the administrator menu is provided to the user;
1-4, wherein a further screen for selection of the camera to be controlled is provided to the user, if the user selects the administrator menu; and
1-5, wherein a further screen for change/control of the camera in four directions, i.e. up, down, left, and right, is provided to the user, if the user selects a specific camera.
